(19) United States
(12) Patent Application Publication
(10) Pub. No.: US 2022/0207435 A1
(43) Pub. Date: Jun. 30, 2022

(54) RESERVATION MANAGEMENT SYSTEM, RESERVATION MANAGEMENT METHOD AND INFORMATION STORAGE MEDIUM

(71) Applicant: Rakuten Group, Inc., Tokyo (JP)

(72) Inventors: Seiichi Takeda, Tokyo (JP); Ryohei Takuma, Tokyo (JP)

(73) Assignee: Rakuten Group, Inc., Tokyo (JP)

(21) Appl. No.: 17/562,686

(22) Filed: Dec. 27, 2021

(30) Foreign Application Priority Data
Dec. 28, 2020 (JP) 2020-219623

(51) Int. Cl. G06Q 10/02; H04W 4/029

(52) U.S. Cl. CPC G06Q 10/02; H04W 4/029

(57) ABSTRACT

A provisional-check-in request data reception module 80 acquires location data indicating a location of a terminal used by a participant. A provisional-check-in processing execution module 82 updates, based on the location indicated by the location data and a location relating to a venue of an event, check-in status data of the participant included in reservation data to check-in status data indicating a provisionally-checked-in status. A check-in processing execution module 86 updates, in response to a check-in request received from any one of a plurality of participants, the check-in status data of another of the participants which is included in the reservation data and which is associated with the check-in status data indicating the provisionally-checked-in status, to the check-in status data indicating a checked-in status.

### CROSS-REFERENCE TO RELATED APPLICATION

The present application claims priority from Japanese application JP 2020-219623 filed on Dec. 28, 2020, the content of which is hereby incorporated by reference into this application.

### BACKGROUND OF THE INVENTION

### 1. Field of the Invention

The present invention relates to a reservation management system, a reservation management method, and an information storage medium.

### 2. Description of the Related Art

In Japanese Patent Application Laid-open No. 2001-000612, there is described a labor-saving system for a golf course which enables savings to the total labor involved with check-in and check-out.

### SUMMARY OF THE INVENTION

In the system as described in Japanese Patent Application Laid-open No. 2001-000612, all players are required to perform check-in at a reception desk of the golf course. However, check-in is often performed in a limited time band in the morning, and therefore a waiting time at the reception desk can occur.

A waiting time at check-in not only occurs for golf, but can also occur in a similar manner at other events as well.

The present invention has been made in view of the above-mentioned problem, and it is an object of the present invention to provide a reservation management system, a reservation management method, and an information storage medium which are capable of reducing a waiting time at check-in.

According to at least one embodiment of the present invention, there is provided a reservation management system including: a reservation request reception module configured to receive a reservation request of an event in which a plurality of participants participate; a reservation data generation module configured to generate, in response to reception of the reservation request, reservation data including check-in status data associated with each of the plurality of participants; a location data acquisition module configured to acquire location data indicating a location of a terminal used by a participant in the plurality of participants; a provisional-check-in processing execution module configured to update, based on the location indicated by the location data and a location relating to a venue of the event, the check-in status data of the participant included in the reservation data to the check-in status data indicating a provisionally-checked-in status; and a check-in processing execution module configured to update, in response to a check-in request received from any one of the plurality of participants, the check-in status data of another of the plurality of participants which is included in the reservation data and which is associated with the check-in status data indicating the provisionally-checked-in status, to the check-in status data indicating a checked-in status.

In at least one aspect of the present invention, the location data acquisition module is configured to acquire the location data transmitted in response to a predetermined operation performed on the terminal.

Further, in at least one aspect of the present invention, the provisional-check-in processing execution module is configured to update, when the location data indicates a location which is a predetermined distance or less from the location relating to the venue, the check-in status data of the participant included in the reservation data to the check-in status data indicating the provisionally-checked-in status.

Further, in at least one aspect of the present invention, the reservation request reception module is configured to receive the reservation request associated with a date and time at which the event is to be held, the reservation data generation module is configured to generate, in response to reception of the reservation request, the reservation data which is further including date and time data indicating the date and time of the event which is associated with the reservation request, the location data acquisition module is configured to acquire the location data associated with a date and time at which the location is determined, and the provisional-check-in processing execution module is configured to update, based on the location indicated by the location data associated with the date and time of determination of the location corresponding to the date and time of the event indicated by the date and time data and based on the location relating to the venue of the event, the check-in status data of the participant included in the reservation data to the check-in status data indicating the provisionally-checked-in status.

Further, in at least one aspect of the present invention, the reservation request reception module is configured to receive the reservation request associated with a name of each of the plurality of participants, the reservation data generation module is configured to generate the reservation data which is further including name data indicating the name of each of the plurality of participants, the location data acquisition module is configured to acquire the location data associated with the name of the participant who uses the terminal, and the provisional-check-in processing execution module is configured to update the check-in status data of the participant identified based on the name associated with the location data to the check-in status data indicating the provisionally-checked-in status.

Further, in at least one aspect of the present invention, the location data acquisition module is configured to acquire the location data indicating a location of each of a plurality of terminals different from each other, and the provisional-check-in processing execution module is configured to update, based on the locations of the plurality of terminals different from each other and the location relating to the venue of the event, all of the plurality of pieces of check-in status data associated with each of the plurality of user terminals to the check-in status data indicating the provisionally-checked-in status.

Further, in at least one aspect of the present invention, the check-in processing execution module is configured to update, in response to reception of the check-in request, the check-in status data of all of the participants associated with the check-in status data indicating the provisionally-checked-in status, to the check-in status data indicating the checked-in status.

Further, according to at least one embodiment of the present invention, there is provided a reservation management method including: receiving a reservation request of an event in which a plurality of participants participate; generating, in response to reception of the reservation request, reservation data including check-in status data associated with each of the plurality of participants; acquiring location data indicating a location of a terminal used by a participant in the plurality of participants; updating, based on the location indicated by the location data and a location relating to a venue of the event, the check-in status data of the participant included in the reservation data to the check-in status data indicating a provisionally-checked-in status; and updating, in response to a check-in request received from any one of the plurality of participants, the check-in status data of another of the plurality of participants which is included in the reservation data and which is associated with the check-in status data indicating the provisionally-checked-in status, to the check-in status data indicating a checked-in status.

Further, according to at least one embodiment of the present invention, there is provided an information storage medium having stored thereon a program for causing a computer to execute the procedures of: receive a reservation request of an event in which a plurality of participants participate;

generate, in response to reception of the reservation request, reservation data including check-in status data associated with each of the plurality of participants; acquire location data indicating a location of a terminal used by a participant in the plurality of participants; update, based on the location indicated by the location data and a location relating to a venue of the event, the check-in status data of the participant included in the reservation data to the check-in status data indicating a provisionally-checked-in status; and update, in response to a check-in request received from any one of the plurality of participants, the check-in status data of another of the plurality of participants which is included in the reservation data and which is associated with the check-in status data indicating the provisionally-checked-in status, to the check-in status data indicating a checked-in status.

### BRIEF DESCRIPTION OF THE DRAWINGS

FIG. 1 is a diagram for illustrating an example of an overall configuration of a computer network in at least one embodiment of the present invention.

FIG. 2A is a diagram for illustrating an example of a configuration of a reservation management server in the at least one embodiment of the present invention.

FIG. 2B is a diagram for illustrating an example of a configuration of a golf course server in the at least one embodiment of the present invention.

FIG. 2C is a diagram for illustrating an example of a configuration of a golf course terminal in the at least one embodiment of the present invention.

FIG. 2D is a diagram for illustrating an example of a configuration of a user terminal in the at least one embodiment of the present invention.

FIG. 3 is a table for showing an example of account data.

FIG. 4 is a table for showing an example of account data.

FIG. 5 is a table for showing an example of golf course data.

FIG. 6 is a diagram for illustrating an example of a reservation screen.

FIG. 7 is a diagram for illustrating an example of a companion registration screen.

FIG. 8 is a diagram for illustrating an example of reservation data.

FIG. 9 is a diagram for illustrating an example of a new companion registration screen.

FIG. 10 is a table for showing an example of account data.

FIG. 11 is a diagram for illustrating an example of a provisional-check-in screen.

FIG. 12A is a table for showing an example of provisional-check-in request data.

FIG. 12B is a table for showing an example of provisional-check-in request data.

FIG. 12C is a table for showing an example of provisional-check-in request data.

FIG. 13 is a diagram for illustrating an example of reservation data.

FIG. 14 is a table for showing an example of account data.

FIG. 15 is a diagram for illustrating an example of a provisionally-checked-in success screen.

FIG. 16 is a diagram for illustrating an example of a barcode display screen.

FIG. 17 is a diagram for illustrating an example of reservation data.

FIG. 18 is a diagram for illustrating an example of a check-in success screen.

FIG. 19 is a function block diagram for illustrating an example of functions of the reservation management server in the at least one embodiment of the present invention.

FIG. 20 is a flow chart for illustrating an example of a flow of processing to be performed in the reservation management server in the at least one embodiment of the present invention.

FIG. 21 is a diagram for illustrating an example of a provisional-check-in approval screen.

FIG. 22 is a flow chart for illustrating an example of a flow of processing to be performed in the reservation management server in the at least one embodiment of the present invention.

### DETAILED DESCRIPTION OF THE INVENTION

Now, at least one embodiment of the present invention is described in detail with reference to the drawings.

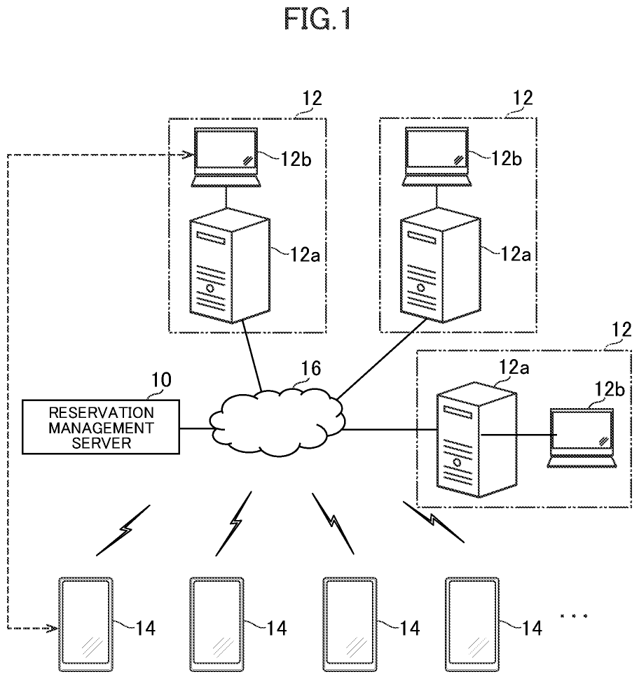

FIG. 1 is a diagram for illustrating an example of an overall configuration of a computer network in the at least one embodiment of the present invention. As illustrated in FIG. 1, a reservation management server 10, a golf course system 12, and a user terminal 14 are connected to a computer network 16 in the at least one embodiment, for example, the Internet.

Consequently, the reservation management server 10, the golf course system 12, and the user terminal 14 can communicate to and from each other via the computer network 16. In FIG. 1, one reservation management server 10 is illustrated, but there may be a plurality of reservation management servers 10.

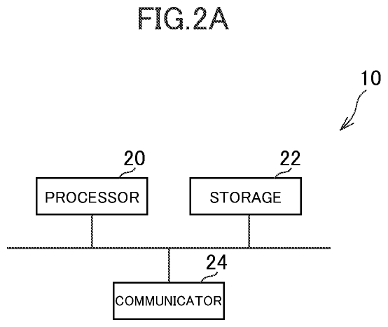

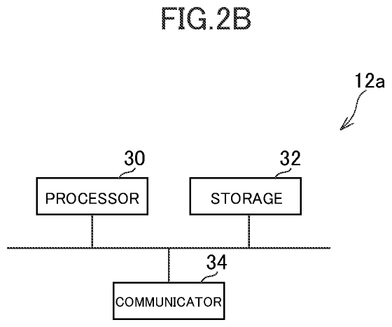

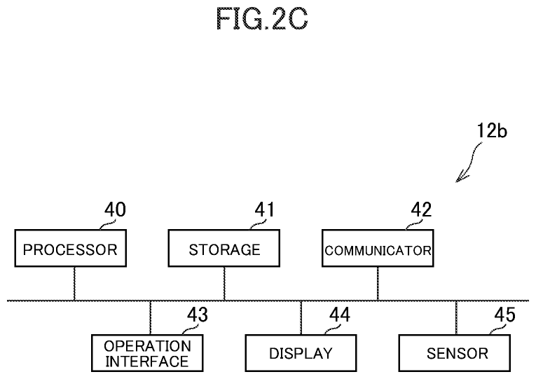

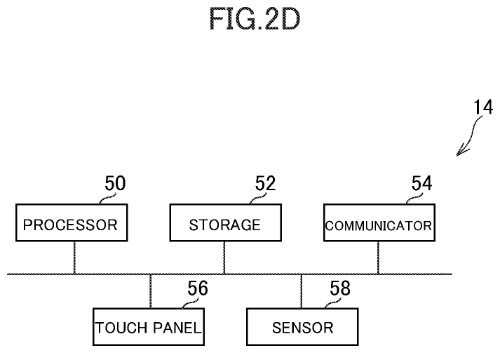

The reservation management server 10 in the at least one embodiment is, for example, a server computer. As illustrated in FIG. 2A, the reservation management server 10 includes a processor 20, a storage 22, and a communicator 24.

The processor 20 is, for example, a program-controlled device, such as a microprocessor, which operates in accordance with a program installed in the reservation management server 10. The storage 22 is, for example, a storage element, such as a ROM or a RAM, or a solid-state drive (SSD). The storage 22 stores, for example, a program to be executed by the processor 20. The communicator 24 is, for example, a communication interface for wired communication or wireless communication, and exchanges data with the golf course system 12 or the user terminal 14 via the computer network 16.

The golf course system 12 in the at least one embodiment is a computer system installed at a golf course. As illustrated in FIG. 1, the golf course system 12 includes, for example, a golf course server 12a and a golf course terminal 12b.

The golf course server 12a is, for example, a server computer. As illustrated in FIG. 2B, the golf course server 12a includes a processor 30, a storage 32, and a communicator 34.

The processor 30 is, for example, a program-controlled device, such as a microprocessor, which operates in accordance with a program installed in the golf course server 12a. The storage 32 is, for example, a storage element, such as a ROM or a RAM, or a solid-state drive (SSD). The storage 32 stores, for example, a program to be executed by the processor 30. The communicator 34 is, for example, a communication interface for wired communication or wireless communication, and exchanges data with the reservation management server 10, the golf course terminal 12b, or the user terminal 14 via the computer network 16.

The golf course terminal 12b is, for example, a computer such as a personal computer or a tablet terminal. As illustrated in FIG. 2C, the golf course terminal 12b includes a processor 40, a storage 41, a communicator 42, an operation interface 43, a display 44, and a sensor 45.

The processor 40 is, for example, a program-controlled device, such as a microprocessor, which operates in accordance with a program installed in the golf course terminal 12b. The storage 41 is, for example, a storage element, such as a ROM or a RAM, or a solid-state drive (SSD). The storage 41 stores, for example, a program to be executed by the processor 40. The communicator 42 is, for example, a communication interface for wired communication or wireless communication, and exchanges data with the golf course server 12a via the computer network 16.

The operation interface 43 is an input device, and includes, for example, a pointing device such as a touch panel or a mouse, and a keyboard. The operation interface 43 transmits operation content to the processor 40. The display 44 is, for example, a liquid crystal display or an organic EL display. The sensor 45 is, for example, a sensing device such as a digital camera or a barcode reader. In the at least one embodiment, there is described a case in which the sensor 45 is included in the golf course terminal 12b, but the sensor 45 may be external to the golf course terminal 12b.

The user terminal 14 in the at least one embodiment is, for example, a portable computer such as a mobile phone (including a smartphone) or a portable information terminal (including a tablet computer). As illustrated in FIG. 2D, the user terminal 14 includes a processor 50, a storage 52, a communicator 54, a touch panel 56, and a sensor 58.

The processor 50 is, for example, a program-controlled device, such as a microprocessor, which operates in accordance with a program installed in the user terminal 14. The storage 52 is, for example, a storage element, such as a ROM or a RAM, or a solid-state drive (SSD). The storage 52 stores, for example, a program to be executed by the processor 50. The communicator 54 is, for example, a communication interface for wired communication or wireless communication, and exchanges data with the reservation management server 10 via the computer network 16.

The touch panel 56 displays and outputs information in accordance with instructions input from the processor 50, and outputs to the processor 50 the content of an operation performed by the user.

The sensor 58 is, for example, a sensing device such as a GPS module, an acceleration sensor, a motion sensor, or a digital camera. In the at least one embodiment, there is described a case in which the sensor 58 is included in the user terminal 14, but the sensor 58 may be external to the user terminal 14.

The programs and data described as being stored in the storages 22, 32, and 52 may be supplied from another computer via a network. Further, the hardware configuration of each of the reservation management server 10, the golf course system 12, and the user terminal 14 is not limited to the example described above, and various types of hardware is applicable. For example, the reservation management server 10, the golf course system 12, and the user terminal 14 may include a reader (for example, an optical disc drive or a memory card slot) for reading a computer-readable information storage medium. Further, for example, the reservation management server 10, the golf course system 12, and the user terminal 14 may include an input/output device (for example, a USB port) for inputting and outputting data to and from an external device. For example, the programs and data stored on the information storage medium may be supplied to the reservation management server 10, the golf course system 12, and the user terminal 14 via the reader or the input/output device.

The reservation management server 10 in the at least one embodiment provides a service for managing reservations of an event in which a plurality of participants participate, for example, a service for managing reservations for playing golf (for example, a round of golf) for a plurality of golf courses.

Further, the reservation management server 10 in the at least one embodiment manages whether or not each of a plurality of participants who have made a reservation for an event, for example, each of a plurality of players who have made a reservation to play golf, has completed check-in. Moreover, at the golf course at which golf is to be played, a staff member of the golf course can confirm whether or not check-in has been completed for each player via the golf course system 12 installed at the golf course.

The golf course system 12 in the at least one embodiment manages, in cooperation with the reservation management server 10, various types of information required at the golf course, for example, information on golf play reservations, at the golf course at which the golf course system 12 is installed.

There is now described, as an example, a situation in which a reservation is made for four users, that is, a user A, a user B, a user C, and a user D, to play golf at a “PPP Country Club” at which the four users are registered as players. Here, for example, the user A makes the reservation as a representative of the four players, and three users, that is, the user B, the user C, and the user D, are registered as companions. The names of the user A, the user B, the user C, and the user D are “AAA”, “BBB”, “CCC”, and “DDD”, respectively.

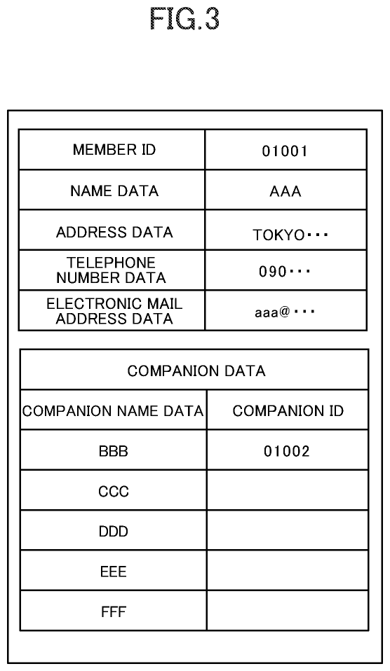

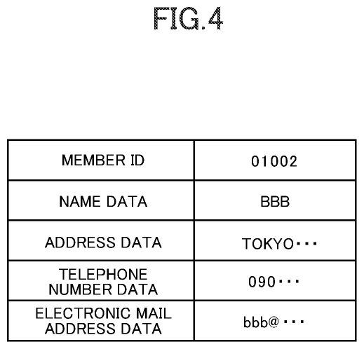

FIG. 3 and FIG. 4 are tables for showing an example of account data registered in the reservation management server 10 in the at least one embodiment. The account data in the at least one embodiment is data generated by a user, who uses the reservation management server 10, performing a predetermined member registration operation on the user terminal 14 used by the user. In the at least one embodiment, users having account data registered in the reservation management server 10 can make a reservation to play golf. The account data in the at least one embodiment can be used not only in the service provided by the reservation management server 10, but also in various services, for example, online shopping.

As shown in FIG. 3 and FIG. 4, the account data in the at least one embodiment includes a member ID, name data, address data, telephone number data, and electronic mail address data.

The account data is data associated with the user using the reservation management server 10. The member ID included in the account data is, for example, information for identifying the user. The name data included in the account data is, for example, data indicating a name of the user. The address data included in the account data is, for example, data indicating an address of the user. The telephone number data included in the account data is, for example, data indicating a telephone number of the user. The electronic mail address data included in the account data is, for example, data indicating an electronic mail address of the user.

In FIG. 3, the account data of the user A is shown. In FIG. 4, the account data of the user B is shown. At the time point at which the reservation to play golf is made by the user A, the account data of the user A and the account data of the user B are registered in the reservation management server 10, but the account data of the user C and the account data of the user D are not registered in the reservation management server 10.

Further, as shown in FIG. 3, the account data in the at least one embodiment may include at least one piece of companion data. The companion data includes companion name data indicating the name of a person registered as a user who may be a companion of the user. Moreover, when the account data of the person is identifiable, the member ID in the account data of the person is set as a companion ID in the companion data including the companion name data indicating the name of the person.

In FIG. 3, there is shown companion data in which a value “BBB” indicating the name of the user B is set in the companion name data, and a value “01002”, which is the member ID of the user B, is set as the companion ID.

Further, in FIG. 3, there is shown companion data for four people including the user C and the user D. A value of a companion ID is not set in the companion data of those people.

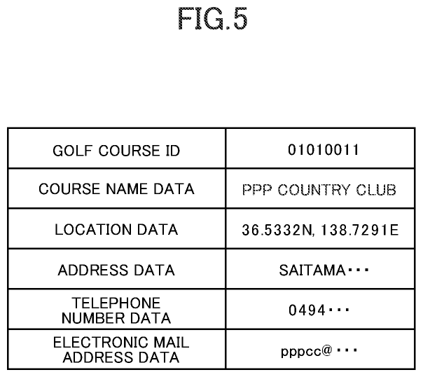

FIG. 5 is a table for showing an example of golf course data stored in the reservation management server 10 in the at least one embodiment. The golf course data includes information on the golf courses which can be reserved by using the reservation management server 10 in the at least one embodiment. The golf course data in the at least one embodiment includes, for example, a golf course ID, course name data, location data, address data, telephone number data, and electronic mail address data.

The golf course data is data associated with a golf course which can be reserved by the reservation management server 10. The golf course ID included in the golf course data is, for example, information for identifying the golf course. The course name data included in the golf course data is, for example, data indicating a name of the golf course. The location data included in the golf course data is, for example, data indicating a location of the golf course. In FIG. 5, the location of the golf course is indicated by latitude and longitude, but the method of expressing the location of the golf course is not limited to latitude and longitude. The address data included in the golf course data is, for example, data indicating an address of the golf course. The telephone number data included in the golf course data is, for example, data indicating a telephone number of the golf course. The electronic mail address data included in the golf course data is, for example, data indicating an electronic mail address of the golf course.

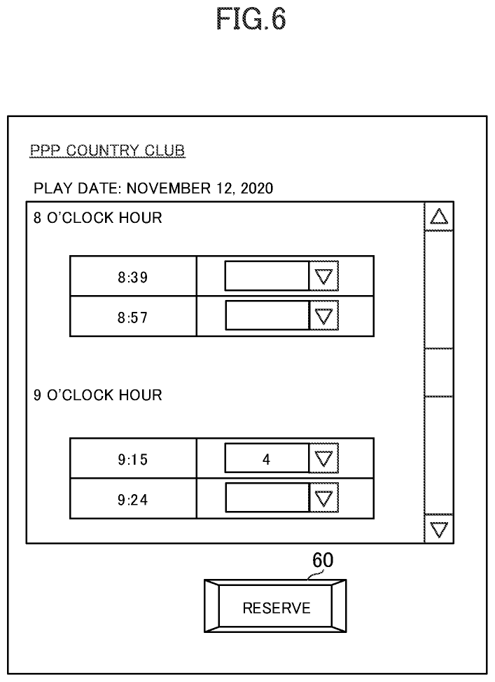

FIG. 6 is a diagram for illustrating an example of a reservation screen displayed on the touch panel 56 of the user terminal 14 used by the user A in the at least one embodiment. In the at least one embodiment, for example, the user A can cause a reservation screen for the “PPP Country Club” like that illustrated in FIG. 6 to be displayed on the touch panel 56 by performing a predetermined operation on the user terminal 14.

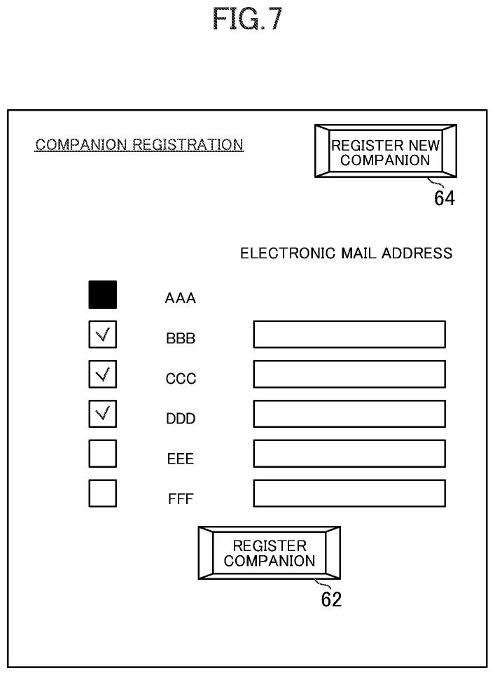

On the reservation screen illustrated in FIG. 6, when the user A performs an operation for setting the date and time and the number of players for the golf play to be reserved and then taps a reservation button 60, a companion registration screen illustrated in FIG. 7 is displayed.

On the companion registration screen, the values of the companion name data included in the account data of the user A are displayed as a list along with the name of the user A who is making the reservation to play golf. As illustrated in FIG. 7, the electronic mail address of each of the companions can be input on the companion registration screen.

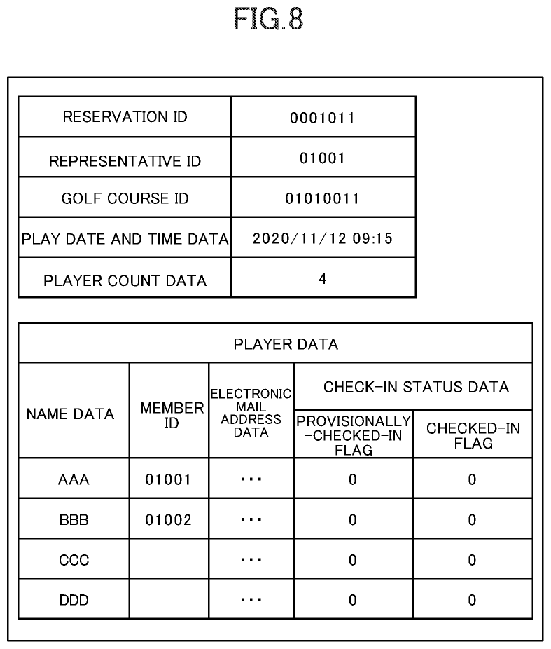

When the user A selects the names of the companions to play golf together and taps a companion registration button 62, reservation data illustrated in FIG. 8 is generated.

As illustrated in FIG. 8, the reservation data includes, for example, a reservation ID, a representative ID, a golf course ID, play date and time data, player count data, and player data. The reservation data is the data associated with one reservation. The reservation ID is, for example, information for identifying the reservation. In the representative ID, for example, the member ID in the account data of the representative user who made the reservation is set. In the golf course ID, for example, the golf course ID in the golf course data of the golf course for which the reservation has been made is set. The play date and time data is, for example, data indicating the play date and time set on the reservation screen. The player count data is, for example, data indicating the number of players set on the reservation screen.

The player data is, for example, data associated with the representative player who made the reservation or a player who is a companion of the representative. In FIG. 8, there are illustrated four sets of player data associated with the user A, the user B, the user C, and the user D, respectively, who are registered as the players in the reservation.

As illustrated in FIG. 8, the player data includes name data, a member ID, electronic mail address data, and check-in status data.

The name data included in the player data is data indicating the name of the player.

In the member ID included in the player data, the member ID in the account data of the user registered as the player is set. Here, the companion ID of the user B is included in the account data of the user A as shown in FIG. 3, and therefore, for the user A and the user B, the values of the member IDs of the player data of those users are set.

The electronic mail address data included in the player data is data indicating the electronic mail address of the player. For example, for the value of the electronic mail address data included in the player data, the electronic mail address of a player input on the companion registration screen may be set, or the value of the electronic mail address data included in the account data of the player may be set.

The check-in status data included in the player data is data indicating the check-in status of the player to play golf. The check-in status in the at least one embodiment is one of, for example, a not-checked-in status, a provisionally-checked-in status, and a checked-in status.

As illustrated in FIG. 8, the check-in status data includes, for example, a provisionally-checked-in flag and a checked-in flag. For example, in the at least one embodiment, for players having the not-checked-in status, the provisionally-checked-in flag and the checked-in flag are both set to a value of 0. For players having the provisionally-checked-in status, the provisionally-checked-in flag is set to a value of 1, and the checked-in flag is set to a value of 0. For players having the checked-in status, the checked-in flag is set to a value of 1.

In the at least one embodiment, immediately after a reservation to play golf is made, that is, immediately after the reservation data is generated, the check-in status is set as the not-checked-in status for all players. More specifically, as illustrated in FIG. 8, the provisionally-checked-in flag and the checked-in flag both have a value of 0.

In the at least one embodiment, in response to the generation of the reservation data, an electronic mail indicating that the reservation is complete may be transmitted from the reservation management server 10 to the electronic mail address indicated by the electronic mail address data included in the player data. Further, a reminder electronic mail may be transmitted from the reservation management server 10 to the electronic mail address a predetermined number of days before the reserved date (for example, 3 days before or 1 day before).

Further, in response to the generation of the reservation data, an electronic mail indicating that a reservation to play golf has been made may be transmitted from the reservation management server 10 to the electron mail address indicated by the electronic mail address data included in the golf course data of the reserved golf course. The electronic mail transmitted from the reservation management server 10 may include, for example, the names of the representative and the companions, the date and time of play, the player count, the electronic mail address of the representative, and the like. The electronic mail transmitted from the reservation management server 10 at the time of reservation does not include personal information on the companions, for example, the addresses and telephone numbers of the companions.

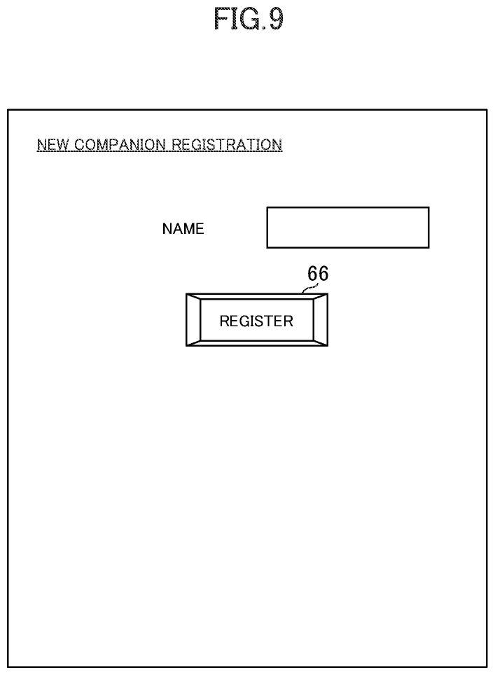

Further, when a new registration button 64 is tapped on the companion registration screen illustrated in FIG. 7, a new companion registration screen illustrated in FIG. 9 is displayed on the touch panel 56. When the user A inputs the name of the new companion on the new companion registration screen and taps a registration button 66, the new companion is registered. In this case, for example, new companion data in which the registered name is set as the value of the companion name data is added to the account data of the user A.

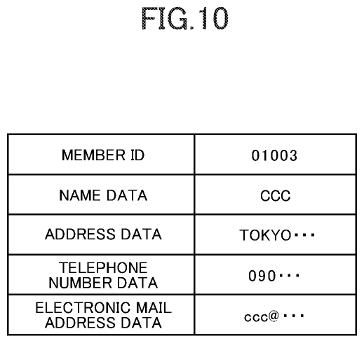

In the at least one embodiment, after the reservation data illustrated in FIG. 8 is generated, the user C performs a predetermined account registration operation, and thus the account data of the user C shown in FIG. 10 is registered in the reservation management server 10.

In the at least one embodiment, for example, on the day of playing golf, provisional check-in can be performed by a user for which account data is registered.

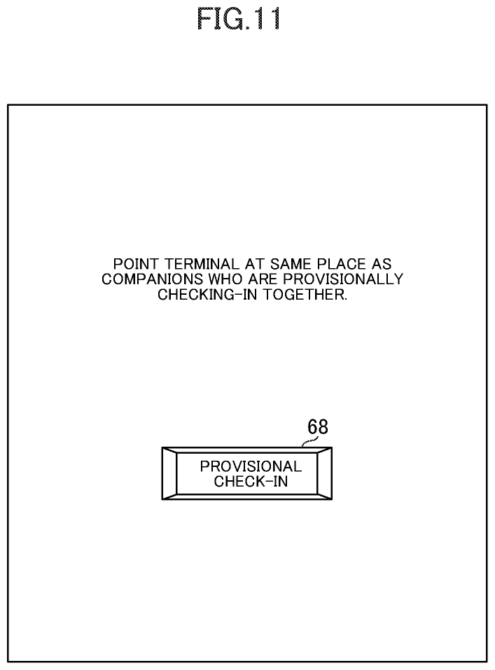

FIG. 11 is a diagram for illustrating an example of a provisional-check-in screen displayed on the touch panel 56 of the user terminal 14 used by a user for which account data is registered when the user performs a predetermined operation. Here, for example, for three users of the user A, the user B, and the user C, the provisional-check-in screen illustrated in FIG. 11 is displayed on the touch panel 56 of the user terminal 14 used by each of the three users.

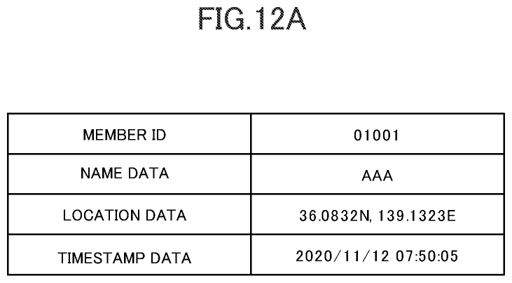

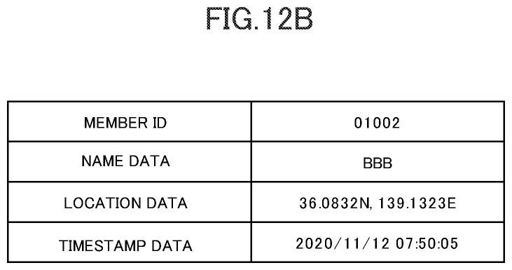

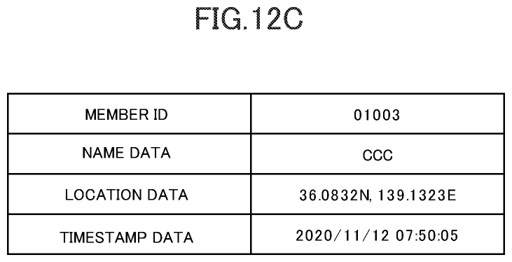

The user A, the user B, and the user C then perform a predetermined operation (hereinafter referred to as “provisional-check-in operation”), for example, tap a provisional-check-in button 68 while pointing each user terminal at a single point in a certain real space which is a predetermined distance or less from the golf course. As a result, each user terminal 14 transmits provisional-check-in request data shown as an example in FIG. 12A to FIG. 12C to the reservation management server 10.

FIG. 12A is a table for showing an example of the provisional-check-in request data transmitted from the user terminal 14 used by the user A. FIG. 12B is a table for showing an example of the provisional-check-in request data transmitted from the user terminal 14 used by the user B. FIG. 12C is a table for showing an example of the provisional-check-in request data transmitted from the user terminal 14 used by the user C.

As shown in FIG. 12A to FIG. 12C, the provisional-check-in request data in the at least one embodiment includes, for example, a member ID, name data, location data, and timestamp data.

The value of the member ID in the account data of the user is set as the value of the member ID included in the provisional-check-in request data. The value of the name data in the account data of the user is set as the value of the name data included in the provisional-check-in request data.

A value indicating the location of the user terminal 14 used by the user is set as the value of the location data included in the provisional-check-in request data. In the at least one embodiment, the user terminal 14 can determine the current location of the user terminal 14 by accessing a general location information service which uses, for example, GPS, base station information, Wi-Fi (trademark), or Bluetooth (trademark). Then, a value indicating the location determined in this way is set as the value of the location data included in the provisional-check-in request data.

A value indicating the date and time at which the location indicated by the location data is determined is set as the value of the timestamp data included in the provisional-check-in request data.

The reservation management server 10 in the at least one embodiment then determines whether or not the provisional-check-in request data transmitted from the user terminal 14 satisfies a predetermined provisional-check-in condition.

Here, for example, a plurality of pieces of provisional-check-in request data satisfying a predetermined condition relating to the location and the date and time are identified. For example, a plurality of pieces of provisional-check-in request data having a distance to the location indicated by the location data of a predetermined distance or less (for example, 5 m or less) and having a difference in date and time of determination of the location indicated by the timestamp data of a predetermined time period or less (for example, 10 seconds or less) are identified. The predetermined condition is not limited to the example described above. For example, another example of another condition relating to the location may be a condition of being accessed via the same base station.

In this way, for example, pieces of provisional-check-in request data of the user A, the user B, and the user C are identified as a plurality of pieces of provisional-check-in request data satisfying the above-mentioned predetermined condition. In the following description, a group including a plurality of users each associated with the plurality of pieces of provisional-check-in request data identified in this manner is referred to as “user group.”

For example, the player data associated with each of the plurality of pieces of provisional-check-in request data associated with the user group is identified. Here, for example, the player data in which the combination of the set value of the member ID and value of the name data matches the combination of the value of the member ID and value of the name data included in the provisional-check-in request data is identified.

In the at least one embodiment, for example, for a user for which player data is not identified by the method described above, the player data in which the set value of the name data matches the value of the name data included in the provisional-check-in request data is identified.

Further, for example, reservation data including player data identified for a plurality of users included in the user group is identified. In this way, the reservation data illustrated in FIG. 8, which include the player data of the user A, the player data of the user B, and the player data of the user C, is identified.

The provisional-check-in request data in the at least one embodiment is not required to include a member ID. In this case, the reservation data including player data in which the set value of the name data matches the value of the name data included in the provisional-check-in request data may be identified.

Then, the golf course data associated with the golf course ID included in the identified reservation data is identified. Then, the distance between the location indicated by the location data included in the identified golf course data and the location indicated by the location data included in the transmitted provisional-check-in request data is identified. Further, the time from the date and time indicated by the timestamp data included in the transmitted provisional-check-in request data to the date and time indicated by the play date and time data included in the identified reservation data is identified.

Then, when the identified distance is a predetermined distance or less and the identified time is a predetermined time period or less, it is determined that the provisional-check-in condition is satisfied.

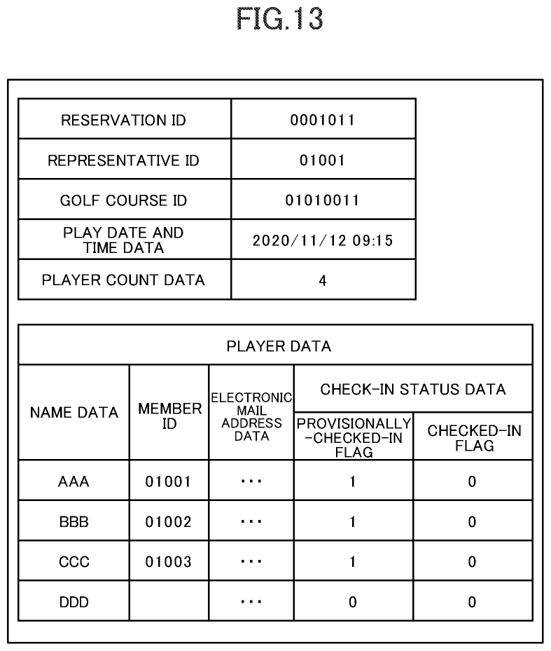

When it is determined that all of the plurality of pieces of provisional-check-in request data associated with the user group satisfy the provisional-check-in condition, the check-in status for the plurality of users included in the user group is updated to the provisionally-checked-in status. Here, for example, as illustrated in FIG. 13, the value of the provisionally-checked-in flag is updated to 1. In FIG. 13, there is illustrated an example in which it is determined that the provisional-check-in condition is satisfied for all of the user A, the user B, and the user C.

Further, in cases in which the value of the member ID has not been set for the player data in which the value of the provisionally-checked-in flag has been updated to 1, the value of the member ID included in the provisional-check-in request data is set as the value of the member ID of the player data. In this case, for example, as the value of the member ID included in the player data of the user C, “01003”, which is the value of the member ID included in the provisional-check-in request data transmitted from the user terminal 14 used by the user C, is set.

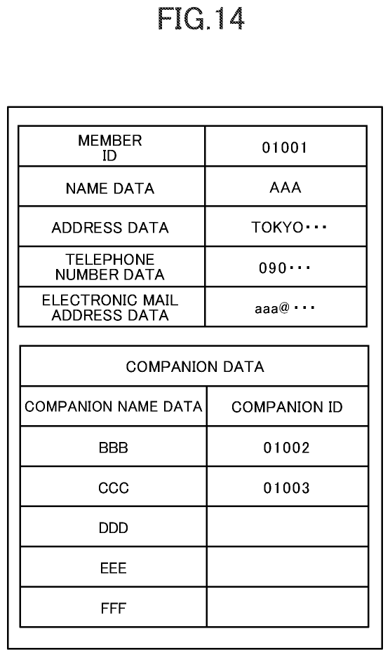

In this case, as shown in FIG. 14, the companion ID of the companion data of the account data associated with the representative ID of the reservation data is also set. In this case, for example, as shown in FIG. 14, “01003”, which is the value of the member ID of the user C, is set as the value of the companion ID associated with the companion name data having the value “CCC”.

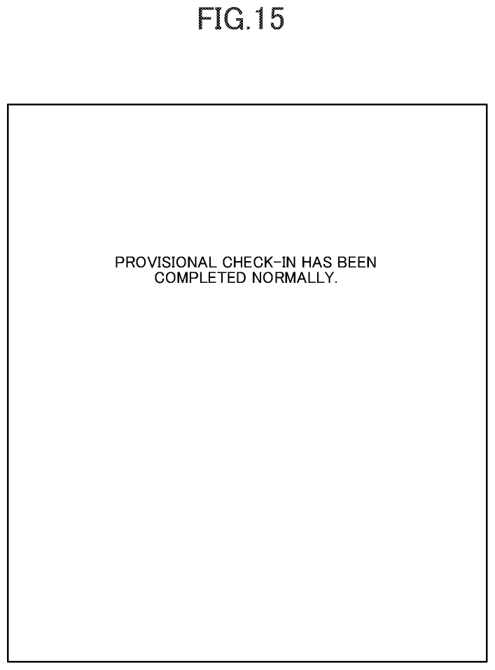

When the reservation management server 10 determines that the provisional-check-in condition is satisfied, a provisionally-checked-in success notification is transmitted to the user terminals 14 of the users included in the user group. The user terminal 14 displays a provisionally-checked-in success screen illustrated in FIG. 15 on the touch panel 56 in response to reception of the provisionally-checked-in success notification.

It is not required that the provisional-check-in operation in the at least one embodiment be performed on the premises of the golf course or at the front desk. For example, the provisional-check-in operation can be performed in various places such as in the vehicle of a club shuttle bus in which a plurality of players ride together, or at a parking area in which the vehicles driven by the players are to meet.

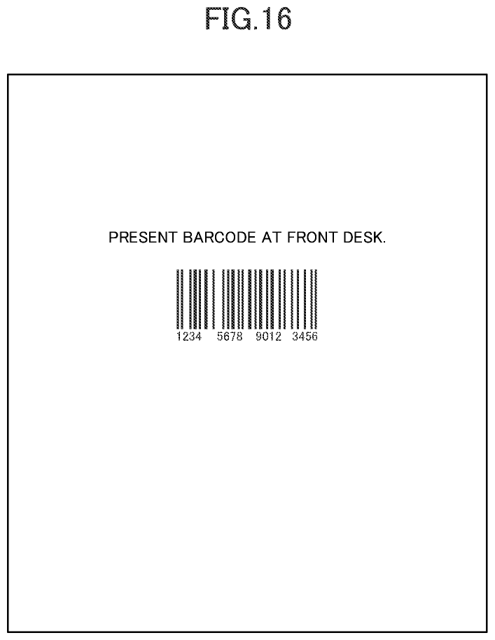

FIG. 16 is a diagram for illustrating an example of a barcode display screen to be used for check-in at the golf course. In the at least one embodiment, for example, when a user for which account data is registered performs a predetermined operation, a barcode display screen is displayed on the touch panel 56 of the user terminal 14 used by the user. The barcode shown on the barcode display screen is associated with the member ID of the user, for example.

In the at least one embodiment, when the user arrives at the golf course at which he or she is to play golf, the user performs a predetermined check-in operation. The check-in operation is, for example, an operation of reading the barcode shown on the barcode display screen by the sensor 45 of the golf course terminal 12b installed at the golf course. The check-in operation is not limited to this operation.

Then, for example, the golf course terminal 12b transmits the check-in request data including the member ID associated with the read barcode to the golf course server 12a. The golf course server 12a transmits the check-in request data to the reservation management server 10. The reservation management server 10 identifies the reservation data in which the value of the member ID is set as the value of the member ID included in the player data. For example, when the user A has performed the check-in operation, the reservation data illustrated in FIG. 13 in which the value of the member ID of the user A is set as the value of the member ID of the player data is identified. The identification (decoding) of the member ID associated with the barcode may be performed by the golf course server 12a or by the golf course terminal 12b. For example, the golf course terminal 12b may transmit an image of the barcode read by the sensor 45 to the golf course server 12a, and the golf course server 12a may identify the member ID associated with the barcode.

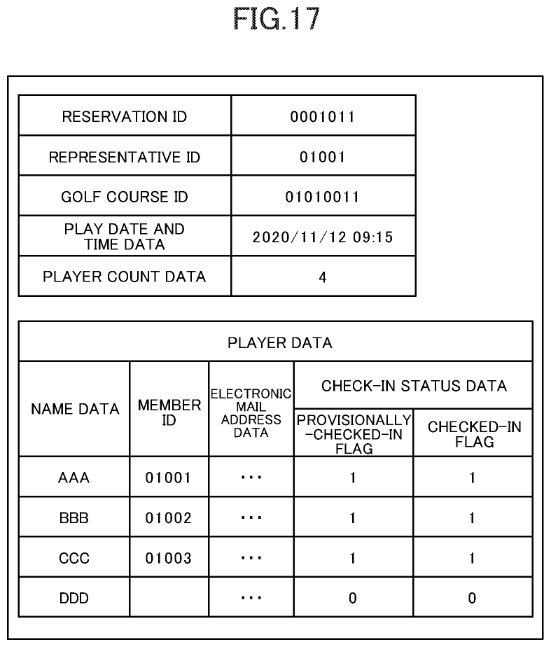

In the reservation data, the player data corresponding to players having the provisionally-checked-in status as their check-in status are identified. Here, for example, the pieces of player data corresponding to each of the user A, the user B, and the user C are identified. As illustrated in FIG. 17, the values of the checked-in flags of the identified pieces of player data are updated to 1. As a result, the user A, the user B, and the user C are changed to having the checked-in status.

The reservation management server 10 generates, based on the account data of the user A, the user B, and the user C, personal information data indicating the personal information, for example, the name, address, telephone number, and electronic mail address, on those users. Then, the reservation management server 10 transmits the identified reservation data and a check-in success notification including the generated personal information data to the golf course server 12a of the golf course system 12 at which the check-in operation is performed. The golf course server 12a then stores the personal information data included in the received check-in success notification in the storage 32. At this timing, the golf course server 12a can now acquire personal information not acquirable at the time of reservation.

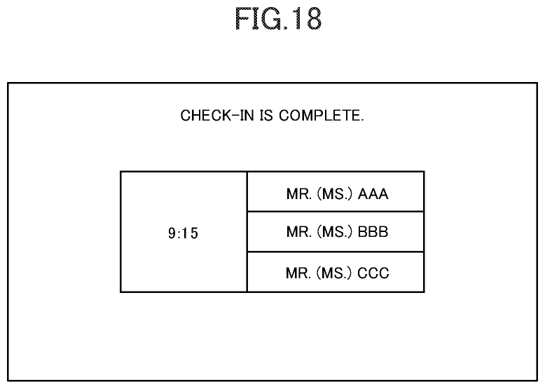

Then, the golf course server 12a executes various types of processing to be executed during check-in which is required for the management of golf play, for example, collating reservation information, notifying that check-in has been successful, and predetermined reception processing. For example, the golf course server 12a generates a check-in success screen illustrated as an example in FIG. 18, and transmits the generated check-in success screen to the golf course terminal 12b. The golf course terminal 12b displays the check-in success screen transmitted from the golf course server 12a on the display 44. In this way, in the at least one embodiment, the user B and the user C can check in at the golf course without performing check-in procedures at the reception desk of the golf course.

In the at least one embodiment, the check-in operation is not required to be performed by the representative user A, and for example, even when a similar check-in operation is performed by the user B or the user C, the user A, the user B, and the user C are changed to having the checked-in status.

When the check-in operation is successful as described above, a golf course staff member may hand over locker keys to the users who have performed the check-in operation. The number of locker keys handed over may be equal to the number of checked-in people.

Later, when the user D performs a normal check-in procedure at the reception desk of the golf course, for example, a golf course staff member performs a predetermined operation on the golf course system 12 to change the check-in status of the user D to the checked-in status as well. That is, the value of the checked-in flag of the player data corresponding to the user D is updated to 1. In this case, the value of the provisionally-checked-in flag of the player data corresponding to the user D may or may not be updated to 1. Further, the golf course staff member may hand over a locker key to the user D who has performed the check-in procedure.

In this way, for example, in the at least one embodiment, players for which account data is not registered can check in by performing the normal check-in procedure at the reception desk of the golf course.

In the above description, when the three users A, B, and C have the provisionally-checked-in status, the check-in statuses of the user A, the user B, and the user C are changed to the checked-in status by the user A performing a check-in operation. However, for example, the number of users having the provisionally-checked-in status user is not required to be three, and may be one, two, or all four.

For example, when only the user A has the provisionally-checked-in status, the user A may be changed to the checked-in status by the user A performing the check-in operation. Further, when the user A and the user B have the provisionally-checked-in status, the user A and the user B may be changed to the checked-in status by the user A performing the check-in operation. In addition, account data is registered for the user D as well, and hence when the user A, the user B, the user C, and the user D each have the provisionally-checked-in status, the user A, the user B, the user C, and the user D may be changed to the checked-in status by the user A performing the check-in operation.

The user performing the check-in operation may have the provisionally-checked-in status or the not-checked-in status. Even when the user performing the check-in operation has the not-checked-in status and not the provisionally-checked-in status, the user may be changed to the checked-in status based on a check-in operation. For example, when the user A has the not-checked-in status and the user B has the provisionally-checked-in status, the user A and the user B may be changed to the checked-in status by the user A performing the check-in operation. In this case, the value of the provisionally-checked-in flag of the player data corresponding to the user who has performed the check-in operation may or may not be updated to 1.

Even when a user who does not have the provisionally-checked-in status performs the check-in operation, it is not required that the user be changed to the checked-in status. That is, there may be a requirement that in order to have the checked-in status, the user is required to have the provisionally-checked-in status in advance.

Later, after playing golf, each user can register data indicating a score in the registration management server 10 via the user terminal 14 used by the user. Further, each user can display on the touch panel 56 the score input by not only the user but also by other users who are in the same group of players as the user via the user terminal 14 used by the user.

In general, all players are required to check in at the reception desk of the golf course. However, check-in is often performed in a limited time band in the morning, and therefore a waiting time at the reception desk can occur.

In the at least one embodiment, as described above, a certain user performs a check-in operation to perform check-in for other users who are reserved as players in the same group as the user and for which their check-in status is provisionally-checked-in. In this case, the other users are not required to perform a check-in operation or check-in procedure. In this way, in the at least one embodiment, the waiting time at check-in can be reduced.

The functions of the reservation management server 10 in the at least one embodiment and the processing to be executed by the reservation management server 10 are now described further.

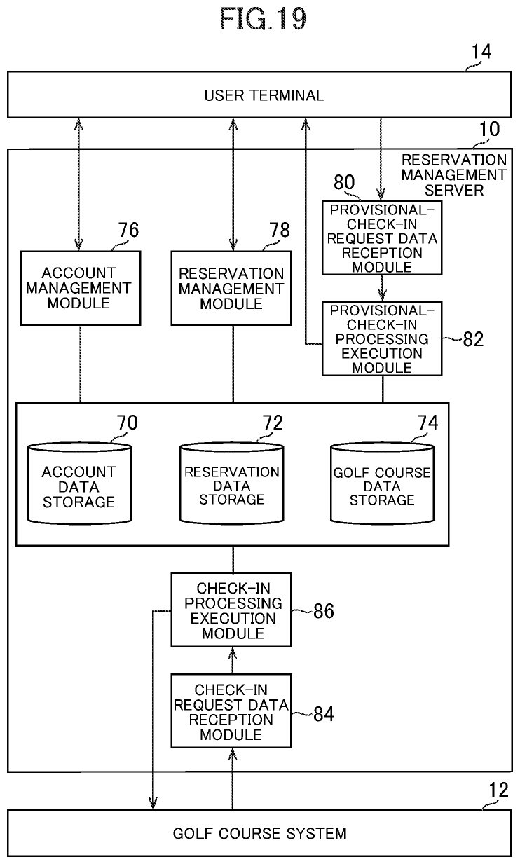

FIG. 19 is a function block diagram for illustrating an example of the functions to be implemented by the reservation management server 10 in the at least one embodiment. It is not required that all of the functions illustrated in FIG. 19 be implemented by the reservation management server 10 in the at least one embodiment, and functions other than the functions illustrated in FIG. 19 may be implemented by the reservation management server 10 in the at least one embodiment.

As illustrated in FIG. 19, the reservation management server 10 in the at least one embodiment includes, as functions, for example, an account data storage 70, a reservation data storage 72, a golf course data storage 74, an account management module 76, a reservation management module 78, a provisional-check-in request data reception module 80, a provisional-check-in processing execution module 82, a check-in request data reception module 84, and a check-in processing execution module 86.

The account data storage 70, the reservation data storage 72, and the golf course data storage 74 are mainly implemented by the storage 22. The account management module 76, the reservation management module 78, the provisional-check-in processing execution module 82, and the check-in processing execution module 86 are mainly implemented by the processor 20 and the communicator 24. The provisional-check-in request data reception module 80 and the check-in request data reception module 84 are mainly implemented by the communicator 24.

The above-mentioned functions may also be implemented by the processor 20 executing a program including commands corresponding to the functions which is installed on the reservation management server 10, which is a computer. Further, the program may be supplied to the reservation management server 10 via a computer-readable information storage medium such as an optical disc, a magnetic disk, a magnetic tape, or a magneto-optical disc, or via the Internet.

In the at least one embodiment, for example, the account data storage 70 stores the account data described above.

In the at least one embodiment, for example, the reservation data storage 72 stores the reservation data described above.

In the at least one embodiment, for example, the golf course data storage 74 stores the golf course data described above.

In the at least one embodiment, for example, the account management module 76 receives a member registration request transmitted from the user terminal 14 in response to a member registration operation performed on the user terminal 14 by the user. The account management module 76 receives the membership registration request, and generates account data. In the at least one embodiment, for example, the account management module 76 then stores the generated account data in the account data storage 70.

In the at least one embodiment, for example, the reservation management module 78 receives reservation requests for an event in which a plurality of participants participate. As described above, the reservation management module 78 may receive a reservation request for golf play in which a plurality of players are to participate.

Further, in the at least one embodiment, for example, in response to reception of the reservation request, the reservation management module 78 generates reservation data including the check-in status data associated with each of the plurality of participants. The reservation management module 78 may generate the reservation data in response to a request received from the user terminal 14. The reservation management module 78 may store the generated reservation data in the reservation data storage 72.

In the at least one embodiment, for example, the provisional-check-in request data reception module 80 acquires location data indicating the location of the user terminal 14 used by a participant. For example, the provisional-check-in request data reception module 80 receives the above-mentioned provisional-check-in request data including the location data indicating the location of the user terminal 14 used by participant.

The provisional-check-in request data reception module 80 may acquire location data transmitted in response to a predetermined provisional-check-in operation performed on the user terminal 14.

In the at least one embodiment, for example, the provisional-check-in processing execution module 82 identifies the location indicated by the acquired location data and a location relating to the venue of the event receiving the reservation request. Further, in the at least one embodiment, for example, the provisional-check-in processing execution module 82 updates, based on those two identified locations, the check-in status data of the participant included in the reservation data to check-in status data indicating a provisionally-checked-in status. Here, for example, the value of the provisionally-checked-in flag included in the check-in status data is updated from 0 to 1.

Further, for example, the provisional-check-in processing execution module 82 may confirm whether or not the acquired location data indicates a location which is a predetermined distance or less from the location relating to the venue. When the acquired location data indicates a location which is a predetermined distance or less from the location relating to the venue, the provisional-check-in processing execution module 82 may update the check-in status data of the participant included in the reservation data to check-in status data indicating the provisionally-checked-in status. In this way, it is possible to set the check-in status of a participant who is highly likely to arrive at the venue of the event to the provisionally-checked-in status.

For example, when the location indicated by the location data for a certain participant has a predetermined distance or less from the golf course at which golf is to be played (for example, 30 km or less), the check-in status data of the participant may be updated to check-in status data indicating the provisionally-checked-in status.

Here, an example of the location relating to the venue of the event receiving the reservation request is, in the example described above, the location of the golf course indicated by the location data included in the golf course data.

The location relating to the venue is not limited to the location of the venue itself. For example, the location of a moving club bus may be sequentially determined by using a sensor included on the club bus. The determined location of the club bus may be used as a location to be compared to the location of the user terminal 14 used by the participant.

For example, when the location indicated by the location data for a certain participant has a predetermined distance or less from the club bus (for example, 5 m or less), the check-in status data of the participant may be updated to check-in status data indicating the provisionally-checked-in status.

In this way, the location relating to the venue is not limited to a fixed location like the location of the golf course, and may be a location which moves over time.

In the at least one embodiment, for example, the check-in request data reception module 84 receives a check-in request from any one of a plurality of participants. The check-in request data reception module 84 may receive the check-in request at the venue of the event receiving the reservation request. For example, the check-in request data reception module 84 may receive check-in request data including a member ID from the golf course system 12.

In the at least one embodiment, for example, the check-in processing execution module 86 identifies, in response to the received check-in request, the check-in status data of the participant, which is included in the reservation data and is associated with check-in status data indicating the provisionally-checked-in status. Here, the check-in status data of another participant different from the participant from which the check-in request has been received may be identified. The check-in processing execution module 86 may, for example, identify reservation data in which the value of the member ID included in the received check-in request data is set as the value of the member ID included in the player data. The check-in processing execution module 86 may also identify the check-in status data which is included in the identified reservation data and which has a provisionally-checked-in flag value of 1.

Further, in the at least one embodiment, for example, the check-in processing execution module 86 updates the identified check-in status data to check-in status data indicating the checked-in status. For example, for check-in status data having a provisionally-checked-in flag value of 1, the value of the checked-in flag is updated from 0 to 1.

As described above, the check-in processing execution module 86 may identify, in response to reception of a check-in request, pieces of check-in status data of all the participants associated with check-in status data indicating the provisionally-checked-in status included in the reservation data. Further, the check-in processing execution module 86 may update all of the identified pieces of check-in status data to check-in status data indicating the checked-in status.

In the at least one embodiment, as described above, provisional-check-in processing may be performed in consideration of the date and time of determination of the location of the user terminal 14 and the date and time at which the event is to be held (in the above-mentioned example, the date and time at which golf is to be played).

For example, the reservation management module 78 may receive a reservation request associated with the date and time at which the event is to be held. Further, in response to reception of such a reservation request, the reservation management module 78 may generate reservation data further including date and time data indicating the event date and time associated with the reservation request. For example, reservation data including play date and time data as illustrated as an example in FIG. 8 may be generated.

The provisional-check-in request data reception module 80 may acquire the location data associated with the date and time of determination of the location of the user terminal 14. For example, provisional-check-in request data including location data and timestamp data as illustrated in FIG. 12A to FIG. 12C may be acquired.

Further, the provisional-check-in processing execution module 82 may update, based on the location indicated by the location data associated with the date and time of determination of the location corresponding to the event date and time indicated by the date and time data, and the location relating to the venue of the event, the check-in status data of the participant included in the reservation data to check-in status data indicating the provisionally-checked-in status.

For example, as described above, when the distance between the location indicated by the location data included in the provisional-check-in request data and the location relating to the venue is a predetermined distance or less (for example, 30 km or less), and when the time from the date and time indicated by the timestamp data included in the provisional-check-in request data until the identified event date and time is a predetermined time period or less (for example, 2 hours or less), the value of the provisionally-checked-in flag of the player data including the combination of the member ID and the name data included in the provisional-check-in request data may be updated to 1.

As described above, the location relating to the venue is not limited to a fixed location like the location of the golf course, and may be a location which moves over time.

Further, in the at least one embodiment, as described above, the reservation data may be identified through use of a name as a key.

For example, the reservation management module 78 may receive a reservation request associated with the name of a participant. Then, the reservation management module 78 may generate reservation data further including name data like that illustrated in FIG. 8, for example, indicating the name of the participant associated with the reservation request.

The provisional-check-in request data reception module 80 may acquire location data associated with the name of a participant using the user terminal 14. For example, the provisional-check-in request data reception module 80 may acquire the above-mentioned provisional-check-in request data, which includes name data indicating the name of the participant. The provisional-check-in processing execution module 82 may identify the reservation data of the participant based on the name associated with the acquired location data. For example, reservation data including the player data in which the name indicated by the included name data matches the name indicated by the name data included in the provisional-check-in request data may be identified.

The provisional-check-in processing execution module 82 may update the check-in status data of the participant identified in this way to check-in status data indicating the provisionally-checked-in status.

In this way, even when the member ID of a player is unknown or not registered at the time of reservation, it is possible to set the check-in status of the player to the provisionally-checked-in status.

Further, in the at least one embodiment, the provisionally-checked-in status of a plurality of participants may be set based on a provisional-check-in operation performed by the plurality of participants.

For example, the provisional-check-in request data reception module 80 may acquire location data indicating the location of each of a plurality of user terminals 14 different from each other. The provisional-check-in processing execution module 82 may update, based on the locations of the plurality of user terminals 14 different from each other and the location relating to the venue of the event, all of the plurality of pieces of check-in status data associated with each of the plurality of user terminals 14 to check-in status data indicating the provisionally-checked-in status.

For example, the provisional-check-in processing execution module 82 may identify a user group associated with a plurality of pieces of provisional-check-in request data which satisfies a predetermined condition relating to the location and the date and time, as described above. Further, the provisional-check-in processing execution module 82 may determine whether or not the provisional-check-in condition is satisfied for each of the plurality of pieces of provisional-check-in request data associated with the user group. Moreover, the provisional-check-in processing execution module 82 may update, when it is determined that all of the plurality of pieces of provisional-check-in request data satisfy the provisional-check-in condition, all of the plurality of pieces of check-in status data associated with each of the provisional-check-in request data to check-in status data indicating the provisionally-checked-in status.

In this case, when the provisional-check-in condition is not satisfied for the plurality of users, the check-in status data of those plurality of users is not updated to the provisionally-checked-in status. In this way, provisional-check-in may be performed under a strict condition.

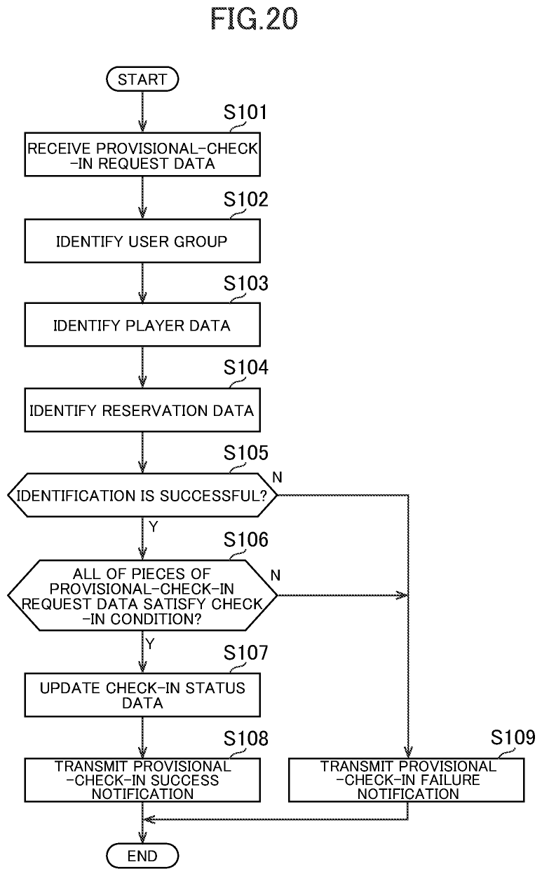

There is now described an example of the flow of provisional-check-in processing to be performed in the reservation management server 10 in the at least one embodiment with reference to the flow chart illustrated in FIG. 20.

First, the provisional-check-in request data reception module 80 receives the provisional-check-in request data described above from the user terminal 14 (Step S101).

Then, the provisional-check-in processing execution module 82 identifies a user group including the user associated with the provisional-check-in request data received in the processing step illustrated in Step S101 (Step S102). In the processing step illustrated in Step S102, for example, a user group associated with a plurality of pieces of provisional-check-in request data satisfying a predetermined condition relating to a location and a date and time is identified.

For example, the location indicated by the location data included in the provisional-check-in request data received in the processing step illustrated in Step S101 may be identified as a reference location. Further, the date and time indicated in timestamp data included in the provisional-check-in request data received in the processing step illustrated in Step S101 may be identified as a reference date and time.

From among the pieces of provisional-check-in request data which have been received, one or a plurality of pieces of provisional-check-in request data having a distance between the location indicated by the location data and the reference location of a predetermined distance or less (for example, 5 m or less) and a date and time of determination of the location indicated by the timestamp data of a predetermined time period or less (for example, 10 seconds or less) may be identified. Further, a user group associated with the one or the plurality of pieces of thus identified provisional-check-in request data and with the provisional-check-in request data received in the processing step illustrated in Step S101 may be identified.

Then, the provisional-check-in processing execution module 82 identifies a plurality of pieces of player data associated with each of the plurality of pieces of provisional-check-in request data associated with the user group identified in the processing step illustrated in Step S102 (Step S103). Here, for example, as described above, the player data in which the combination of the set value of the member ID and value of the name data matches the combination of the value of the member ID and value of the name data included in the provisional-check-in request data may be identified. As another example, the player data in which the value of the set name data matches the value of the name data included in the provisional-check-in request data may be identified.

Then, the provisional-check-in processing execution module 82 identifies the reservation data including the plurality of pieces of player data identified in the processing step illustrated in Step S103 (Step S104).

The provisional-check-in processing execution module 82 confirms whether or not the reservation data is successfully identified in the processing step illustrated in Step S104 (Step S105).

When it is confirmed that the reservation data has been successfully identified (Step S105: Y), the provisional-check-in processing execution module 82 checks whether or not all of the plurality of pieces of provisional-check-in request data associated with the user group identified in the processing step illustrated in Step S102 satisfy the provisional-check-in condition (Step S106).

Here, for example, (1) it may be confirmed whether or not a condition that the distance between the location indicated by the location data included in the golf course data associated with the identified reservation data and the location indicated by the location data included in the provisional-check-in request data is a predetermined distance or less (for example, 30 km or less) is satisfied. Further, (2) it may be confirmed whether or not a condition that the time from the date and time indicated by the timestamp data included in the provisional-check-in request data to the date and time indicated by the play date and time data included in the identified reservation data is a predetermined time period or less (for example, 2 hours or less) is satisfied.

When it is confirmed that both conditions (1) and (2) are satisfied, it may be determined that the provisional-check-in request data satisfies the provisional-check-in condition. Meanwhile, when it is confirmed that any one of the conditions (1) and (2) are not satisfied, it may be determined that the provisional-check-in request data does not satisfy the provisional-check-in condition.

When it is confirmed that all of the plurality of pieces of provisional-check-in request data associated with the user group identified in the processing step illustrated in Step S103 satisfy the provisional-check-in condition (Step S106: Y), the provisional-check-in processing execution module 82 updates the check-in status data for the plurality of pieces of player data identified in the processing step illustrated in Step S103 so that the value of the provisionally-checked-in flag included in the player data becomes 1 (Step S107). At this time, a notification that those players now have the provisionally-checked-in status may be transmitted to the golf course system of the golf course associated with the reservation data identified in the processing step illustrated in Step S104.

The provisional-check-in processing execution module 82 transmits a provisional-check-in success notification to the plurality of user terminals 14 used by each of the plurality of users included in the user group identified in the processing step illustrated in Step S102 (Step S108), and then the processing illustrated in this processing example is ended. The user terminal 14 receives the provisional-check-in success notification, and displays the provisional-check-in success screen illustrated as an example in FIG. 15 on the touch panel 56.

When it is confirmed that identification of the reservation data has failed in the processing step illustrated in Step S105 (Step S105: N), or when it is confirmed in the processing step illustrated in Step S106 that any one of the plurality of pieces of provisional-check-in request data associated with the user group identified in the processing step illustrated in Step S102 does not satisfy the provisional-check-in condition (Step S106: N), in any one of those cases, the provisional-check-in processing execution module 82 transmits a provisional-check-in failure notification to the plurality of user terminals 14 used by each of the plurality of users included in the user group identified in the processing step illustrated in Step S102 (Step S109), and the processing illustrated in this processing example is ended. The user terminal 14 receives the provisional-check-in failure notification, and displays a screen indicating that the provisional-check-in has failed on the touch panel 56.

In the at least one embodiment, the representative user, for example, may control whether or not to approve provisional-check-in for another user.

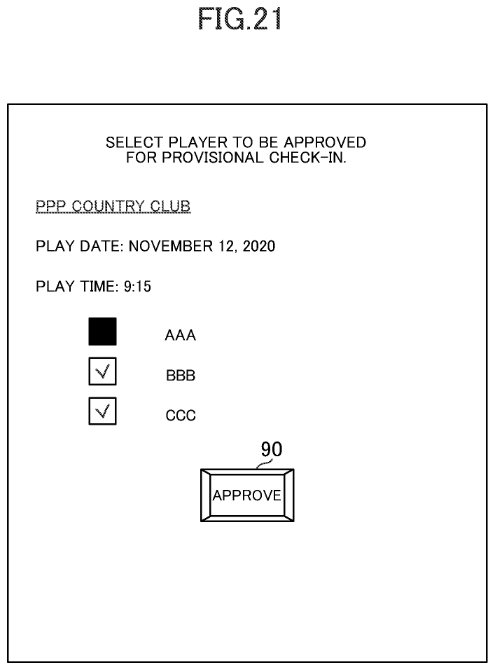

For example, when it is confirmed in the processing step illustrated in Step S106 that all of the plurality of pieces of provisional-check-in request data associated with the user group identified in the processing step illustrated in Step S102 satisfy the provisional-check-in condition, for example, the provisional-check-in processing execution module 82 may generate a provisional-check-in approval screen illustrated as an example in FIG. 21, and transmit the generated provisional-check-in approval screen to the user terminal 14 of the representative user. On the provisional-check-in approval screen illustrated as an example in FIG. 21, the names of the plurality of users included in the user group are arranged in association with a checkbox.

The user terminal 14 of the representative user may display the received provisional-check-in approval screen on the touch panel 56.

When the representative user selects the check box of a user for which provisional check-in is to be approved and taps an approval button 90, the user terminal 14 may transmit approved user data indicating the name of the selected user to the reservation management server 10. The provisional-check-in processing execution module 82 of the reservation management server 10 may then update the check-in status data so that the value of the provisionally-checked-in flag included in the player data of the user associated with the user name indicated by the received approved user data becomes 1.

Further, in response to a request from the representative user, for example, the reservation management server 10 in the at least one embodiment may return the check-in status of a user specified by the user making the request from the provisionally-checked-in status to the not-checked-in status. For example, in response to a request from the representative user, for example, the check-in status data may be updated so that the value of the provisionally-checked-in flag included in the player data of the user specified by the user making the request becomes 0.

Further, in the at least one embodiment, each player may perform provisional-check-in individually without identification of the user group.

For example, in the processing step illustrated in Step S103, the player data corresponding to the provisional-check-in request data received in the processing step illustrated in Step S101 may be identified without executing the processing step illustrated in Step S102. Further, the reservation data including the player data may be identified, and it may be confirmed whether or not the provisional-check-in request data received in the processing step illustrated in Step S101 satisfies the provisional-check-in condition. When it is confirmed that the provisional-check-in request data received in the processing step illustrated in Step S101 satisfies the provisional-check-in condition, the check-in status data may be updated such that the value of the provisionally-checked-in flag included in the player data identified in the processing step illustrated in Step S103 becomes 1.

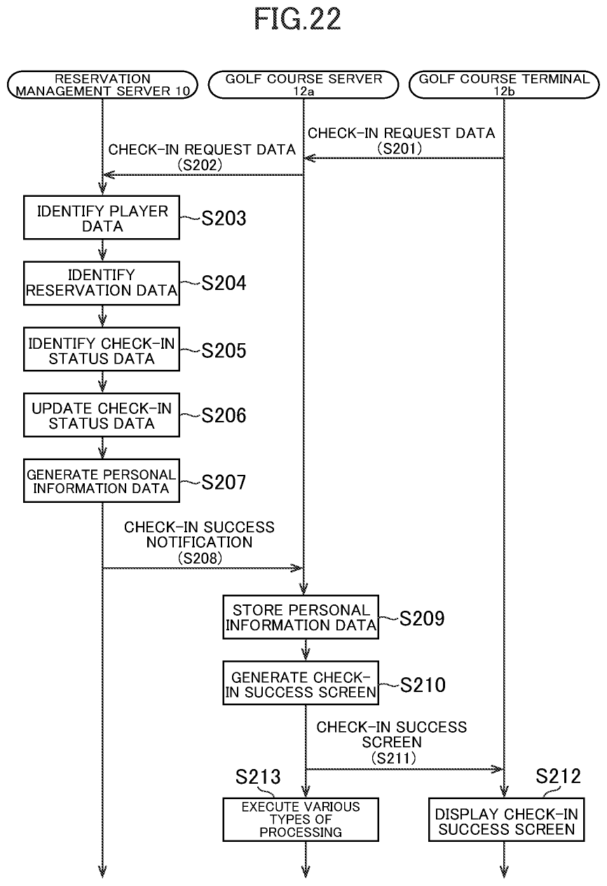

Next, an example of a flow of check-in processing to be performed in the reservation management server 10 and the golf course system 12 in the at least one embodiment is described with reference to the flow chart illustrated as an example in FIG. 22.

First, when the user performs a check-in operation, the golf course terminal 12b transmits check-in request data including the member ID of the user to the golf course server 12a. Then, the golf course server 12a receives the check-in request data (Step S201).

Then, the golf course server 12a transmits the check-in request data received in the processing step illustrated in Step S201 to the reservation management server 10. Then, the check-in request data reception module 84 receives the check-in request data (Step S202).

The check-in processing execution module 86 then identifies the player data including the member ID included in the check-in request data received in the processing step illustrated in Step S202 (Step S203).

Then, the check-in processing execution module 86 identifies the reservation data in which the player data including the member ID included in the check-in request data received in the processing step illustrated in Step S202 is included (Step S204).

Then, the check-in processing execution module 86 identifies which of the pieces of check-in status data included in the reservation data identified in the processing step illustrated in Step S204 has a provisionally-checked-in flag value of 1 (Step S205). In this processing, a plurality of pieces of check-in status data may be identified.

The check-in processing execution module 86 then updates the one or the plurality of pieces of check-in status data identified in the processing step illustrated in Step S205 so that the value of the included checked-in flag becomes 1 (Step S206).

Then, the check-in processing execution module 86 generates personal information data based on the account data of the users for which the check-in status data has been updated in the processing step illustrated in Step S206 (Step S207).

The check-in processing execution module 86 then transmits the reservation data identified in the processing step illustrated in Step S204 and a check-in success notification including the personal information data generated in the processing step illustrated in Step S207 to the golf course server 12a, which is the transmission source of the check-in request data received in the processing step illustrated in Step S201. Then, the golf course server 12a receives the check-in success notification (Step S208).

The golf course server 12a stores the personal information data included in the check-in success notification received in the processing step illustrated in Step S208 in the storage 32 (Step S209).

Then, the golf course server 12a generates the check-in success screen illustrated as an example in FIG. 18 (Step S210).

Then, the golf course server 12a transmits the check-in success screen generated in the processing step illustrated in Step S210 to the golf course terminal 12b. The golf course terminal 12b receives the check-in success screen (Step S211).

Then, the golf course terminal 12b displays the received check-in success screen on the display 44 (Step S212).

The golf course server 12a then executes various types of other processing to be executed during check-in which are required in order to manage the golf play (Step S213), and the processing illustrated in this processing example is ended.

In the processing example described above, for example, the golf course server 12a may identify the member ID included in the check-in request data received from the golf course terminal 12b. Then, the golf course server 12a may transmit to the reservation management server 10 a transmission request for the personal information data associated with the identified member ID in place of the check-in request data.

The check-in processing execution module 86 may execute similar processing to that illustrated in the above-mentioned Step S203 to Step S205 based on the member ID associated with the transmission request, and identify one or a plurality of pieces of check-in status data having a provisionally-checked-in flag value of 1.

Further, the check-in processing execution module 86 may generate personal information data based on the account data of the user associated with each of the one or the plurality of pieces of identified check-in status data.

The check-in processing execution module 86 may transmit the generated personal information data to the golf course server 12a.

The golf course server 12a may store the received personal information data in the storage 32.

The check-in processing execution module 86 may update the one or the plurality of pieces of identified check-in status data so that the value of the included checked-in flag becomes 1.

Further, the processing steps illustrated in Step S210 to Step S213 described above may be executed.

In this way, updating of the check-in status data may be executed after transmission of the personal information data. That is, updating of the check-in status data may be triggered by the transmission of the personal information data.

In the example described above, the check-in status data may be updated after the personal information data is generated. Further, the personal information data may be transmitted after the check-in status data is updated. That is, updating of the check-in status data may be triggered by the generation of the personal information data.

As described above, the execution order of the processing steps illustrated in Step S206 to Step S208 of FIG. 22 is not particularly limited. Further, the execution order of the other processing steps illustrated in FIG. 22 is not particularly limited.

The present invention is not limited to the at least one embodiment described above.

For example, when a plurality of users perform a provisional-check-in operation, the provisional-check-in request data of the plurality of users may be transmitted from the user terminal 14 used by any one of those plurality of users. For example, when the user A, the user B, and the user C perform a provisional-check-in operation, the provisional-check-in request data of the user B may be transmitted from the user terminal 14 of the user B to the user terminal 14 of the user A by direct communication (for example, near-field wireless communication) which does not go through the computer network 16. Further, the provisional-check-in request data of the user C may be transmitted from the user terminal 14 of the user C to the user terminal 14 of the user A by direct communication (for example, near field wireless communication) which does not go through the computer network 16. Moreover, the provisional-check-in request data of the user A, the provisional-check-in request data of the user B, and the provisional-check-in request data of the user C may be transmitted from the user terminal 14 of the user A to the reservation management server 10.

Further, even for a user for which account data is not registered, a provisional-check-in operation may be performed. In this case, a device ID of the user terminal 14 used by the user may be used in place of the member ID. Then, in response to later registration of the account data performed via the user terminal 14, the device ID may be replaced by the member ID assigned to the account data.

Further, the setting of the value of the member ID in player data for which the value of the member ID is not set and addition of a companion ID to the companion data of the account data may be executed when the check-in processing is performed rather than when the provisional-check-in processing is performed.

Further, in place of a barcode, a two-dimensional code, for example, a QR code (trademark), associated with the member ID may be displayed on the screen used for check-in at the golf course.

Further, the at least one embodiment is applicable not only to reserving a round for a one group, but also to reserving a round for two or more groups.

Further, the role sharing among the reservation management server 10, the golf course system 12, and the user terminal 14 is not limited to the example described above. For example, a part or all of the functions illustrated in FIG. 19 may be implemented in the golf course system 12 or the user terminal 14.

Further, the event in the at least one embodiment is not limited to playing golf. For example, the present invention is also applicable to events in which various sports are played, such as bowling, billiards, and darts, and matchmaking parties in which a plurality of participants participate with one person acting as the representative.

Further, the specific character strings and numerical values described above and the specific numerical values and character strings in the drawings are merely exemplary, and the present invention is not limited to those character strings and numerical values.

While there have been described what are at present considered to be certain embodiments of the invention, it will be understood that various modifications may be made thereto, and it is intended that the appended claims cover all such modifications as fall within the true spirit and scope of the invention.

What is claimed is:

1. A reservation management system, comprising:
at least one processor; and
at least one memory device storing instructions which, when executed by the at least one processor, cause the at least one processor to perform operations comprising:
receiving a reservation request of an event in which a plurality of participants participate;
generating, in response to reception of the reservation request, reservation data including check-in status data associated with each of the plurality of participants;
acquiring location data indicating a location of a terminal used by a participant in the plurality of participants;
updating, based on the location indicated by the location data and a location relating to a venue of the event, the check-in status data of the participant included in the reservation data to the check-in status data indicating a provisionally-checked-in status; and
updating, in response to a check-in request received from any one of the plurality of participants, the check-in status data of another of the plurality of participants which is included in the reservation data and which is associated with the check-in status data indicating the provisionally-checked-in status, to the check-in status data indicating a checked-in status.

2. The reservation management system according to claim 1, wherein acquiring the location data transmitted in response to a predetermined operation performed on the terminal.

3. The reservation management system according to claim 1, wherein updating, when the location data indicates a location which is a predetermined distance or less from the location relating to the venue, the check-in status data of the participant included in the reservation data to the check-in status data indicating the provisionally-checked-in status.

4. The reservation management system according to claim 1,
wherein receiving the reservation request associated with a date and time at which the event is to be held,
wherein generating, in response to reception of the reservation request, the reservation data which is further including date and time data indicating the date and time of the event which is associated with the reservation request,
wherein acquiring the location data associated with a date and time at which the location is determined, and
wherein updating, based on the location indicated by the location data associated with the date and time of determination of the location corresponding to the date and time of the event indicated by the date and time data and based on the location relating to the venue of the event, the check-in status data of the participant included in the reservation data to the check-in status data indicating the provisionally-checked-in status.

5. The reservation management system according to claim 1,
wherein receiving the reservation request associated with a name of each of the plurality of participants,
wherein generating the reservation data which is further including name data indicating the name of each of the plurality of participants,
wherein acquiring the location data associated with the name of the participant who uses the terminal, and
wherein updating the check-in status data of the participant identified based on the name associated with the location data to the check-in status data indicating the provisionally-checked-in status.

6. The reservation management system according to claim 1,
wherein acquiring the location data indicating a location of each of a plurality of terminals different from each other, and
wherein updating, based on the locations of the plurality of terminals different from each other and the location relating to the venue of the event, all of the plurality of pieces of check-in status data associated with each of the plurality of user terminals to the check-in status data indicating the provisionally-checked-in status.

7. The reservation management system according to claim 1, wherein updating, in response to reception of the check-in request, the check-in status data of all of the participants associated with the check-in status data indicating the provisionally-checked-in status, to the check-in status data indicating the checked-in status.

8. A reservation management method, comprising:
receiving a reservation request of an event in which a plurality of participants participate;
generating, in response to reception of the reservation request, reservation data including check-in status data associated with each of the plurality of participants;
acquiring location data indicating a location of a terminal used by a participant in the plurality of participants;
updating, based on the location indicated by the location data and a location relating to a venue of the event, the check-in status data of the participant included in the reservation data to the check-in status data indicating a provisionally-checked-in status; and
updating, in response to a check-in request received from any one of the plurality of participants, the check-in status data of another of the plurality of participants which is included in the reservation data and which is associated with the check-in status data indicating the provisionally-checked-in status, to the check-in status data indicating a checked-in status.

9. An information storage medium having stored thereon a program for causing a computer to execute the procedures of:
receive a reservation request of an event in which a plurality of participants participate;
generate, in response to reception of the reservation request, reservation data including check-in status data associated with each of the plurality of participants;
acquire location data indicating a location of a terminal used by a participant in the plurality of participants;
update, based on the location indicated by the location data and a location relating to a venue of the event, the check-in status data of the participant included in the reservation data to the check-in status data indicating a provisionally-checked-in status; and
update, in response to a check-in request received from any one of the plurality of participants, the check-in status data of another of the plurality of participants which is included in the reservation data and which is associated with the check-in status data indicating the provisionally-checked-in status, to the check-in status data indicating a checked-in status.
